(19) United States
(12) Patent Application Publication
(10) Pub. No.: US 2010/0232629 A1
(43) Pub. Date: Sep. 16, 2010

(54) SOUND VIBRATOR HAVING TUNING FORK

(76) Inventor: Seong Sig Choi, Gyeonggi-Do (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/733,965

(22) PCT Filed: Jun. 25, 2008
(86) PCT No.: PCT/KR2008/003614

§ 371 Date: Mar. 31, 2010

(30) Foreign Application Priority Data
Oct. 31, 2007 (KR) 10-2007-0109892

(51) Int. Cl. H04R 9/02

(52) U.S. Cl. 381/162; 381/400

(57) ABSTRACT

A sound vibrator having tuning fork has developed, which is comprising a coil for receiving a sound signal from exterior to generate a magnetic force, a magnet for interacting with the magnetic force generated by the coil, a basket for accommodating the magnet, a face plate for transmitting up-and-down movement of the coil or the magnet to skin, and a tuning fork type band having an end contact to the magnet and the other end contacting to the coil for receiving vibration or sound generated by the magnet and the coil for simultaneously outputting the vibration and sound.

### TECHNICAL FIELD

The present invention relates to a tuning fork type sound vibrator, and more particularly, to a tuning fork type sound vibrator adopting a tuning fork type vibrator that most softly transmits sound to control sound and vibration and allows a significant decrease in cost.

### BACKGROUND ART

A conventional body-sonic vibration vibrator or a bone-conduction vibrator, which contacts a human body to transmit sound, generates vibration at a central area thereof contacting a human body and transmits the vibration to the outer side weakly. Particularly, since the conventional body-sonic vibration vibrator or the bone-conduction vibrator contacts a rear side of an auricle, the closer the conventional body-sonic vibration vibrator or the bone-conduction vibrator contacts the ear and the skull the easier it is to transmit sound when the conventional body-sonic vibration vibrator or the bone-conduction vibrator is used. However, since sound or vibration is generated from a central region of the conventional body-sonic vibration vibrator or the bone-conduction vibrator, the conventional body-sonic vibration vibrator or the bone-conduction vibrator cannot closely contact the ear and the skull unless reducing a size of the conventional body-sonic vibration vibrator or the bone-conduction vibrator.

Moreover, in a conventional speaker, a high frequency sound is generated from the inside where a coil is placed and a low frequency sound is generated from a diaphragm out of the coil. In a small size speaker unit, the diaphragm has a size restriction and has a difficulty to generate the low frequency sound, and the bone-conduction vibrator has the same restriction.

### DISCLOSURE OF INVENTION

### Technical Problem

However, an earphone or a headphone including the above-mentioned body-sonic vibration vibrator or the bone-conduction vibrator generates vibration from a central area contacting a human body and due to this has a size restriction when the vibrator contact a specific portion of the human body.

For example, the closer the earphone or the speaker, including the above-mentioned body-sonic vibration vibrator or the bone-conduction vibrator, contacts the rear sides of auricles and skull the easier sound is transmitted. However, since sound and vibration are generated from the central area of the vibrator, the vibrator cannot closely contact the ears and the skull unless reducing the sizes of the earphone and the headphone.

Thus, when the earphone and the headphone including the conventional body-sonic vibrator or the bone-conduction vibrator receive an input from an audio player such as an MP3 player, an amplifier must be used to increase an output.

Moreover, in open air earphone or headphone, a tympanic membrane could be damaged when the open air earphone or headphone is used by plugging ears for a long time. In order for the diaphragm to generate sound in the state of plugging ears, the diaphragm continuously vibrates up and down. In this case, since the ears are plugged and the diaphragm continuously pumps air to press the ears, the ears may be stunned when the open air earphone or headphone is used for a long time.

### Technical Solution

Therefore, the present invention has been made in view of the above problems, and it is an object of the present invention to provide a tuning fork type sound vibrator comprising: a coil (12) receiving a sound signal from the exterior to generate a magnetic force; a magnet (15) interacting with the magnetic force generated by the coil (12); a basket (16) accommodating the magnet (15); a face plate (11) transmitting up-and-down movement of the coil (12) or the magnet (15) to skin; and a tuning fork type band (13) including an end contacting the magnet (15) and the other end contacting the coil (12) and receiving vibration or sound generated by the magnet (15) and the coil (12) to simultaneously output the vibration and sound.

Preferably, the tuning fork type band (13) comprises at least one contacting member (17) contacting a case (20) of an earphone and a speaker.

The vibration and the sound that are transmitted from the tuning fork type band (13) to the case (20) of the earphone and the speaker are different from each other in accordance with contacting areas and portions of the contacting members (17) against the case (20) caused by the number, positions, and thicknesses of the contacting members (17).

The tuning fork type band (13) comprises at least one magnet (15), coil (12), and basket (16) whereby different vibrations and sounds are output.

The tuning fork type sound vibrator further comprises a base plate (18) inserted between the coil (12) and the tuning fork type band (13), wherein a high frequency sound or a low frequency sound is output in accordance with material of the base plate (18).

The face plate (11) protrudes out of the case (20) through a hole formed in a side of the case (20) to directly contact the inner wall of an auditory canal and to transmit the vibration.

### ADVANTAGEOUS EFFECTS

According to the present invention, the tuning fork type sound vibrator combines vibration and sound generated from a magnet with vibration and sound generated from a coil, so that a rich sound can be transmitted even from a low input.

Moreover, since the tuning fork type sound vibrator of the present invention re-produces various sounds even by changing area or thickness of a contacting portion connecting a tuning fork type band to an external case, various types of products can be easily manufactured.

When using earphones including a tuning fork type sound vibrator supporting a low frequency sound, a user can watch a downloaded film using an PMP, a computer, an MP4, and the like which are widely used while experiencing loudness of sound like watching a film in a theater.

Furthermore, since the low frequency sound could be generated even where a band to which the coil is attached holds the magnet, even a small size unit can reproduce a rich low frequency sound like a large speaker does.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a tuning fork type sound vibrator according to an embodiment of the present invention;

FIG. 2 is a view illustrating a case in which the tuning fork type sound vibrator according to the embodiment of the present invention is mounted;

FIG. 3 is a view illustrating a region to which a face plate of the tuning fork type sound vibrator according to the embodiment of the present invention may be positioned;

FIG. 4 is a view illustrating the tuning fork type sound vibrator according to another embodiment of the present invention installed in an in-ear type vibration earphone;

FIG. 5 is a view illustrating a tuning fork type sound vibrator according to still another embodiment of the present invention; and

FIG. 6 is a view illustrating a face plate, connected to the tuning fork type sound vibrator according to still another embodiment of the present invention, partially protruding out of a case of an earphone.

### BEST MODE FOR CARRYING OUT THE INVENTION

Hereinafter, a tuning fork type sound vibrator according to preferred embodiments of the present invention will be described in detail with reference to the accompanying drawings.

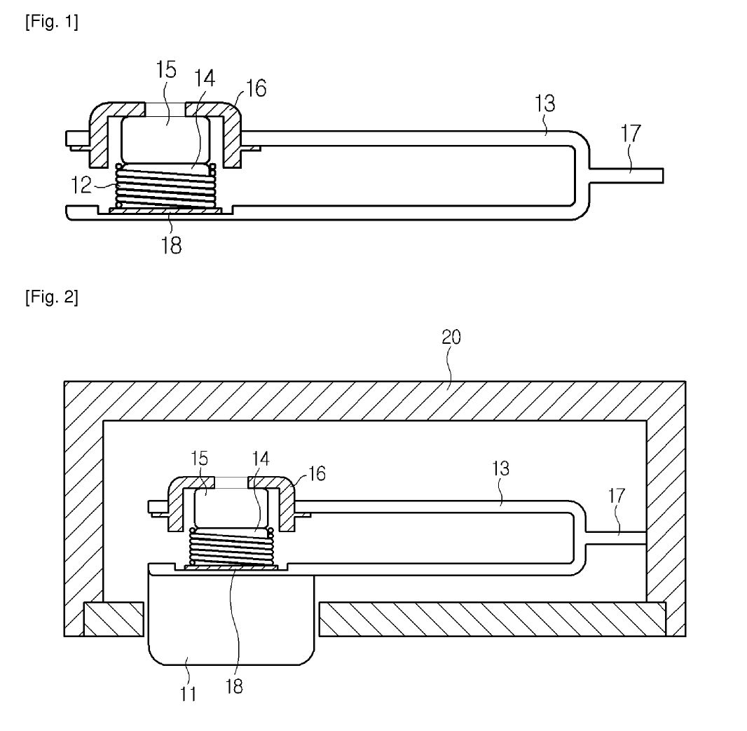

FIG. 1 is a sectional view illustrating a tuning fork type sound vibrator.

As illustrated in FIG. 1, the tuning fork type sound vibrator 10 according to an embodiment of the present invention includes a face plate 11, a coil 12, a tuning fork type band 13, a magnetic radiation cylinder 14, a magnet 15, a basket 16, a contacting member 17, and a base plate 18.

The face plate 11 directly contacts human skin and transmits internal vibration to the human skin. The face plate 11 contacts the human skin to transmit sound from a speaker to the human skin and is made of soft material such as silicon to softly transmit sound generated due to vibration in the speaker to the human skin. In other words, the face plate 11 is a sound transmitting cylinder finally transmitting sound and is configured to regulate sound stress by regions of sound and to softly transmit the sound.

The coil 12 is attached with heat-resistant rubber based strong adhesive to receive a sound signal input from an exterior through a lead line (not shown) so as to drive a corresponding speaker unit.

The magnet 15 and the basket 16 are positioned at an upper portion of the coil 12 such that the magnet 15 is installed in the basket 16.

The hollow magnet 15 is fixed to the metal basket 16 in a state of being placed on a ceiling of the basket 16 by a magnetic force and a bonding force, and is a neodymium magnet.

In the box-shaped basket 16 having a depressed interior space, the magnet 15 is received in an internal circumferential surface of the basket 16 such that a gap is constant between the circumferential surface and the magnet 15 and the coil 12 is placed in the gap between the magnet 15 and the basket 16.

Preferably, the magnet 15 and the basket 16 are bonded to each other by ultrasonic vibration bonding and with adhesive.

The basket 16 is configured to primarily damp sound and to convert an air flow into a desired direction, and functions as a main body determining the connection of all components.

Thus, when an electrical sound signal is applied from the exterior to the coil 12, attractive and repulsive physical vibrating force is generated due to interaction between a magnetic force generated by the coil 12 and a magnetic field of the magnet 15 and the coil 12 and the magnet 15 vibrate up and down.

In other words, the vibrating force caused by the application of the sound signal induces the vibration of the coil 12 and the magnet 15.

The magnetic radiation cylinder 14 is positioned between the coil 12 and the magnet 15 to make magnetic fluxes.

When a sound signal is transmitted from various sound generating apparatuses such as an MP3 player, an MP4 player, a CD player, and the like to the tuning fork type sound vibrator according to the embodiment of the present invention, the tuning fork type band 13, an end of which is connected to the face plate 11 and the other end of which is connected to the basket 16, combines vibration or sound generated from the magnet 15 with vibration or sound generated from the coil 12 to provide a high output even at a low input.

In general, although vibration is simultaneously generated from the magnet and the coil, since only the vibration generated from the coil is output, the vibration range must be amplified by an amplifier. However, since the tuning fork type band 13 is provided, the tuning fork type sound vibrator 10 according to the embodiment of the present invention harmoniously controls and outputs vibrations or sounds generated from the magnet 15 and the coil 12.

The contacting member 17 is configured to simultaneously transmit vibration and sound by contacting an inner surface of an outer case when the tuning fork type sound vibrator 10 according to the embodiment of the present invention is installed in the outer case.

FIG. 2 is a view illustrating the tuning fork type sound vibrator 10 according to the embodiment of the present invention mounted in an earphone case 20.

In an existing product, since the very center of a sound and vibration transmitting plate 21 of the case 20 is punctured and the face plate 11 is placed in the punctured area, sound is concentrated on the center of the sound and vibration transmitting plate 21 and is weakly transmitted through an edge portion of the sound and vibration transmitting plate 21.

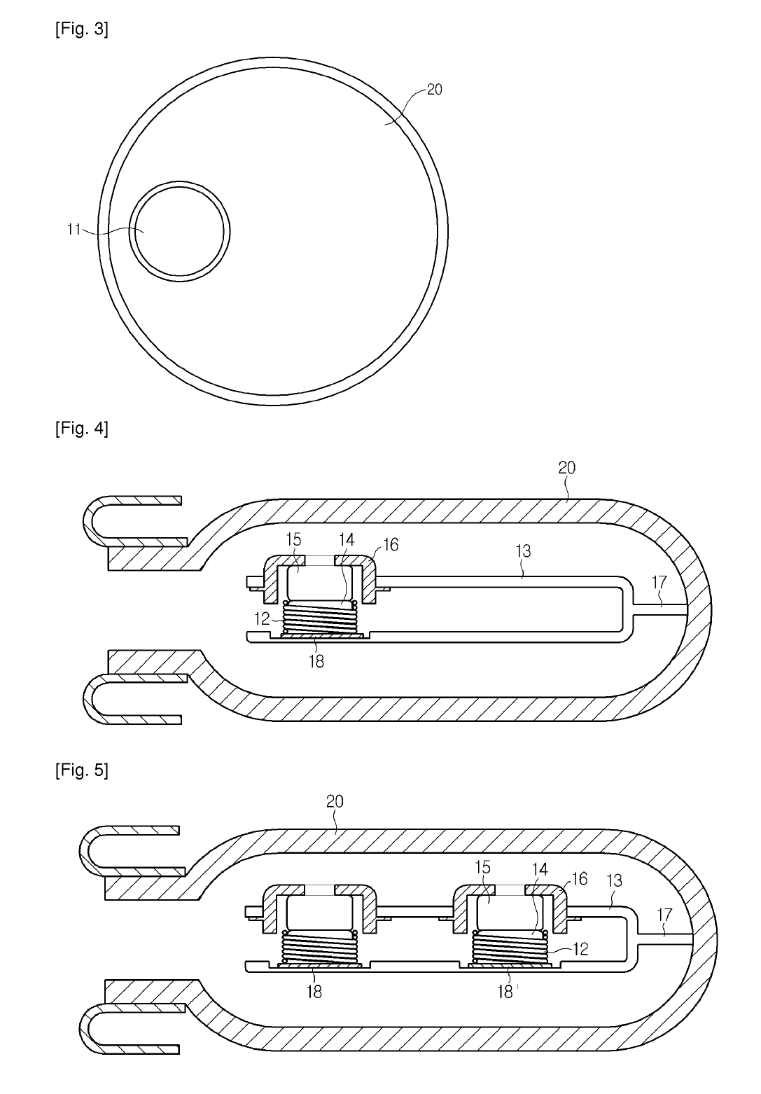

However, since the area where the face plate of FIG. 2 is placed is asymmetrically punctured in an area other than the very center of the sound and vibration transmitting plate 21 as illustrated in FIG. 3, the position of the face plate 11 is freely changed so that sound and vibration can be also freely controlled.

FIG. 4 illustrates an in-ear type vibration earphone in which the tuning fork type sound vibrator 10 according to another embodiment of the present invention is installed.

As illustrated in FIG. 4, a case 20 of the in-ear type vibration earphone to be inserted into an auditory canal has a bottle-shape with an opened side and a space accommodating the tuning fork type sound vibrator according to another embodiment of the present invention.

The bottle-shaped earphone case 20 having the space and the opened side forms an overall external appearance of the earphone, and is configured to reinforce the magnetic radiating function of a magnet 50 so that the tuning fork type sound vibrator 10 realizes a virtual theater sound in the earphone case 20 in association with the face plate 11.

Meanwhile, a tuning fork type band 12 as a component of the tuning fork type sound vibrator 10 includes a plurality of contacting members 17. The contacting members 17 contact an inner surface of the bottle-shaped earphone case 20 to uniformly transmit vibration and sound which are generated from the magnet 15 and a coil 12 to the earphone case 20.

In this case, portions or areas of the earphone case 20 contacting the contacting members 17 of the tuning fork type sound vibrator 10 are changed so that various sounds can be reproduced.

Sound is mostly transmitted through the opened side and vibration is mostly transmitted through the earphone case 20 inserted into and contacting the auditory canal of a user.

A base plate 18 is made of a thin metal, plastic, or other material and is inserted into a contacting portion between the band 13 and the coil 12 to generate various sounds (high frequency sound or low frequency sound). As illustrated in FIG. 1, the base plate 18 is inserted either between the coil 12 and the band 13 or between the coil 12 and the face plate 11 as illustrated in FIG. 2 to induce a variation of sound.

In other words, the base plate 18 generates high frequency sound when the base plate 18 is made of metal and low frequency sound when the base plate 18 is made of plastic.

Although only the case when the base plate 18 is made of metal or plastic is described, the base plate 18 may be made of wood, glass, or the like, and more particularly, generates various sounds due to kinds of metal, strength of plastic, and other factors.

A tuning fork type sound vibrator according to still another embodiment of the present invention will be described with reference to FIG. 5.

FIG. 5 illustrates a tuning fork type band 13, a component of a tuning fork type sound vibrator according to still another embodiment of the present invention, to which a pair of baskets 16, respectively including a coil 12, a magnetic radiation plate 14, a magnet 14, and a base plate 18, is installed.

Since the pair of baskets 16 is installed to the band 13, an earphone including the tuning fork type sound vibrator according to still another embodiment of the present invention can reproduce a loud sound.

When the base plates 18 provided in the baskets 16 are made of different materials, sound may be deeper. In other words, one 18 of the base plates 18 is made of a metal plate to produce high frequency sound and the other 18 is made of a plastic plate to produce low frequency sound.

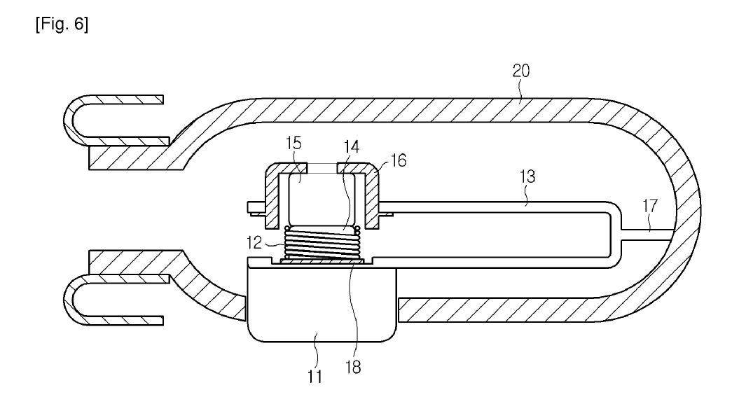

FIG. 6 is a view illustrating a tuning fork type sound vibrator in which an in-ear type earphone case 20 is punctured such that a face plate 11 protrudes out of the earphone case 20 like a case of FIG. 2.

The face plate 11 protrudes out of the in-ear type earphone case 20 so that the in-ear type earphone is inserted into an auditory canal of a user to vibrate cartilage of the auditory canal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1-6. (canceled)

7. A sound vibrator having tuning fork comprising:
a coil (12) for receiving a sound signal from exterior to generate a magnetic force,
a magnet (15) for interacting with the magnetic force generated by the coil (12),
a basket (16) for accommodating the magnet (15),
a face plate (11) for transmitting up-and-down movement of the coil (12) or the magnet (15) to skin, and
a tuning fork type band (13) including an end contacting the magnet (15) and the other end contacting the coil (12) for receiving vibration or sound generated by the magnet (15) and the coil (12) for simultaneously outputting the vibration and sound.

8. The sound vibrator as claimed in claim 7, wherein the tuning fork type band (13) comprises at least one contacting member (17) contacting a case (20) of an earphone and a speaker.

9. The sound vibrator as claimed in claim 8, wherein the vibration and sound that are transmitted from the tuning fork type band (13) to the case (20) of earphone and speaker are different from each other in accordance with contacting areas and portions of contacting members (17) against the case (20) caused by the number, positions, and thicknesses of the contacting members (17).

10. The sound vibrator as claimed in claim 7, wherein the tuning fork type band (13) comprises at least one magnet (15), coil (12), and basket (16) for outputting different vibrations and sounds.

11. The sound vibrator as claimed in claim 7, further comprising a base plate (18) inserted between the coil (12) and the tuning fork type band (13), wherein a high frequency sound and/or a low frequency sound are outputting in accordance with material of the base plate (18).

12. The sound vibrator as claimed in claim 8, wherein the face plate (11) has protruded out of the case (20) through a hole formed in a side of the case (20) to directly contact to inner wall of an auditory canal for transmitting the vibration.
